(19) United States
(12) Patent Application Publication
(10) Pub. No.: US 2026/0186708 A1
(43) Pub. Date: Jul. 2, 2026

(54) MEMORY CONTROLLER, METHOD OF OPERATING THE SAME, AND SYSTEM INCLUDING THE SAME

(71) Applicant: Samsung Electronics Co., Ltd., Suwon-si (KR)

(72) Inventors: Changjun Lee, Suwon-si (KR); Sangwoo Kim, Suwon-si (KR); Yongjun Cho, Suwon-si (KR)

(21) Appl. No.: 19/369,570

(22) Filed: Oct. 27, 2025

(30) Foreign Application Priority Data
Dec. 31, 2024 (KR) 10-2024-0202741

(51) Int. Cl. G06F 3/06

(52) U.S. Cl. CPC G06F 3/0659; G06F 3/061; G06F 3/0679

(57) ABSTRACT

A memory controller communicating with a host device including a plurality of initiators includes an initiator priority table including priority information of each of the plurality of initiators, wherein the plurality of initiators are identified by using a plurality of initiator identifiers, a first command queue configured to store a plurality of commands issued by the plurality of initiators in a receipt order in which the plurality of commands are received from the host device, a scheduler configured to extract a plurality of initiator priority values of the plurality of commands stored in the first command queue from the initiator priority table, and reorder the plurality of commands in an execution order, based on the plurality of initiator priority values and a plurality of task attributes of the plurality of commands, and a second command queue configured to store the plurality of commands in the execution order.

### CROSS-REFERENCE TO RELATED APPLICATION

This application is based on and claims priority under 35 U.S.C. §119 to Korean Patent Application No. 10-2024-0202741, filed on December 31, 2024, in the Korean Intellectual Property Office, the disclosure of which is incorporated by reference herein in its entirety.

### BACKGROUND

The inventive concept relates to a memory controller, a method of operating the same, and a system including the same, and more particularly, to a memory controller that schedules commands based on priorities of a plurality of initiators included in a host.

Memory semiconductors are widely used to store data in various electronic devices such as computers and wireless communication devices. Non-volatile memory, a type of memory semiconductor, is a device that may store data even when power is not supplied to the device. Various mobile devices or electronic devices such as smartphones, desktop computers, laptop computers, tablet personal computers (PCs), and wearable devices are widely used. Such electronic devices include storage devices for storing data. Universal Flash Storage (UFS) devices may be used as storage devices in mobile devices, portable devices, automotive electronics, or embedded systems.

A UFS device may receive a plurality of commands from a host, and thus, a method is desirable to improve an efficiency of the operation of the UFS device by processing commands with higher priority first.

### SUMMARY

The inventive concept is to manage priorities of initiators included in a host by using an initiator priority table, and to improve the performance of a memory device by first processing commands with higher priorities based on the priorities of the initiators.

The technical problems of the inventive concept are not limited to the technical problems mentioned above, and other technical problems which are not mentioned are clearly understood by those skilled in the art from the description below.

According to an aspect of the present disclosure, a memory controller communicating with a host device including a plurality of initiators includes an initiator priority table including priority information of each of the plurality of initiators, wherein the plurality of initiators are identified by using a plurality of initiator identifiers, a first command queue configured to store a plurality of commands issued by the plurality of initiators in a receipt order in which the plurality of commands are received from the host device, a scheduler configured to extract a plurality of initiator priority values of the plurality of commands stored in the first command queue from the initiator priority table, and reorder the plurality of commands in an execution order, based on the plurality of initiator priority values and a plurality of task attributes of the plurality of commands, and a second command queue configured to store the plurality of commands in the execution order. The scheduler is configured further to execute, in the execution order, the plurality of commands stored in the second command queue.

According to an aspect of the present disclosure, a method of operating a memory controller communicating with a host device including a plurality of initiators includes receiving a plurality of commands issued by the plurality of initiators from the host device, storing the plurality of commands in a first command queue in a receipt order of the plurality of commands from the host device, extracting a plurality of initiator priority values of the plurality of commands from an initiator priority table, storing the plurality of commands in a second command queue in an execution order based on the plurality of initiator priority values and a plurality of task attributes of the plurality of commands, and executing, in the execution order, the plurality of commands stored in the second command queue.

A system includes a host device and a memory controller communicating with the host device. The host device includes a first initiator and a second initiator which issue a plurality of commands. The memory controller comprises an initiator priority table including initiator identifier information and initiator priority information of each initiator of the first initiator and the second initiator, a first command queue configured to store the plurality of commands in a receipt order in which the plurality of commands are received from the host device, a scheduler configured to extract a plurality of initiator priority values of the plurality of commands stored in the first command queue from the initiator priority table, and reorder the plurality of commands in an execution order, based on the plurality of initiator priority values and a plurality of task attributes of the plurality of commands, and a second command queue configured to store the plurality of commands in the execution order.

### BRIEF DESCRIPTION OF THE DRAWINGS

Embodiments of the inventive concept will be more clearly understood from the following detailed description taken in conjunction with the accompanying drawings in which:

FIG. 1 is a block diagram illustrating a system according to an embodiment;

FIG. 2 is a block diagram illustrating a memory controller according to an embodiment;

FIG. 3 is a diagram illustrating an initiator priority table according to an embodiment;

FIG. 4 is a drawing illustrating an implementation example of a command issued by a host according to an embodiment;

FIG. 5 is a block diagram illustrating a system according to an embodiment;

FIG. 6 is a diagram illustrating an initiator priority table according to an embodiment;

FIGS. 7 and 8 are drawings illustrating a first command queue and a second command queue according to an embodiment;

FIG. 9 is a flowchart illustrating an operation method of a memory controller, according to an embodiment;

FIG. 10 is a flowchart illustrating an operation method of a memory controller, according to an embodiment; and

FIG. 11 is a block diagram illustrating a UFS system according to an embodiment.

### DETAILED DESCRIPTION OF THE EMBODIMENTS

Hereinafter, embodiments of the inventive concept are described in detail with reference to the attached drawings. When explaining with reference to drawings, identical or corresponding components are given the same drawing reference numerals and any description already given for the components is omitted.

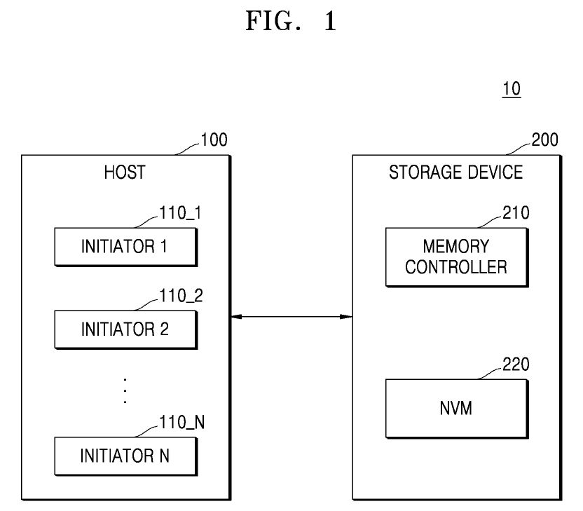

FIG. 1 is a block diagram illustrating a system 10 according to an embodiment.

Referring to FIG. 1, the system 10 may include a host 100 and a storage device 200. In some embodiments, the system 10 may be referred to as a Universal Flash Storage (UFS) system or a storage system.

In this specification, the host 100 and the storage device 200 may be connected to each other in accordance to specifications defined in the UFS standard specification published by Joint Electron Device Engineering Council (JEDEC). In an embodiment, the host 100 may be a UFS host, and the storage device 200 may be a UFS storage device. In some embodiments, the host 100 may be referred to as a host device or a UFS host device. In some embodiments, the UFS standard specification may include various versions, such as, but not limited to, UFS 4.0, UFS 4.1, or UFS 5.0.

The host 100 may include a plurality of initiators 110_1 to 110_N (where N is a natural number greater than or equal to 2). The host 100 may execute an operating system (OS) and/or various applications by using the plurality of initiators 110_1 to 110_N. The host 100 may include a physical layer, a multi-protocol multiplexer, interface circuits, coherence/cache circuits, bus circuits, at least one core, and input/output devices. The plurality of initiators 110_1 to 110_N may access the same storage device 200.

Each of the plurality of initiators 110_1 to 110_N may be a device implemented as hardware for processing data stored in a storage device 200, such as a central processing unit (CPU), a graphics processing unit (GPU), a neural processing unit (NPU), an application processor (AP), and a small computer system interface (SCSI) device.

In an embodiment, each of the plurality of initiators 110_1 to 110_N may include the same type of hardware or different types of hardware. For example, the first initiator 110_1 may be a CPU, and the second initiator 110_2 may be a CPU. In this case, the performance of the first initiator 110_1 may be different from the performance of the second initiator 110_2. In addition, for example, the first initiator 110_1 may be a CPU, and the second initiator 110_2 may be a GPU.

Each of the plurality of initiators 110_1 to 110_N may issue a command to the storage device 200. The command issued by each of the plurality of initiators 110_1 to 110_N may be a command to write data into a non-volatile memory 220 of the storage device 200, or to read or erase data stored in the non-volatile memory 220.

The plurality of initiators 110_1 to 110_N may have different priorities from each other. For example, a priority of the first initiator 110_1 may be higher than a priority of the second initiator 110_2. A priority of each of plurality of initiators 110_1 to 110_N may be referred to as initiator priority in this specification and may be determined based on various criteria. For example, each initiator may be set to have a high priority depending on a performance of the initiator, or may be set to have a different priority depending on a type of initiator.

In an embodiment, initiator priority information and initiator identifier information for the plurality of initiators 110_1 to 110_N may be information predefined and already stored in the host 100. The host 100 may provide a configuration descriptor to the storage device 200. The configuration descriptor may include the initiator priority information and the initiator identifier information for the plurality of initiators 110_1 to 110_N.

The storage device 200 may include a memory controller 210 and a non-volatile memory device (NVM) 220. In an embodiment, the storage device (200) may be a UFS, an embedded multimedia card (eMMC), a solid state drive (SSD), or a multimedia card (MMC).

The storage device 200 may receive a plurality of commands from the host 100. The memory controller 210 may control the non-volatile memory 220 to write data to the non-volatile memory 220 or read data stored in the non-volatile memory 220 in response to the command received from the host 100.

In an embodiment, the memory controller 210 may control a write operation (or program operation), a read operation, or an erase operation for the non-volatile memory 220 based on the command received from the host 100. Additionally, data to be written and data to be read may be transmitted and received between the memory controller 210 and the non-volatile memory 220.

The memory controller 210 may process (i.e., execute) a command issued by an initiator with a high priority prior to a command issued by an initiator with a low priority. The memory controller 210 may determine a processing order (i.e., an execution order) of the command, based on a task attribute included in the command provided by the host 100 and an initiator priority table.

In an embodiment, the initiator priority table may be generated based on the configuration descriptor received from the host 100. For example, the memory controller 210 may receive the configuration descriptor from the host 100 and generate the initiator priority table.

The non-volatile memory 220 may be flash memory. The flash memory may include a two dimensional NAND memory array or a 3D (or vertical) NAND (VNAND) memory array. The 3D memory array is an array of memory cells having an active area arranged on a silicon substrate, or a circuit related to an operation of the memory cells, which is formed monolithically on at least one physical level of a circuit formed on the substrate or within the substrate. The term "monolithic" means that layers of each level making up the array are stacked on layers of each lower level in the array.

As another example, the storage device 200 may include various other types of non-volatile memories. For example, the storage device 200 may be applied with various types of memory, including read only memory (ROM), programmable ROM (PROM), electrically PROM (EPROM), electrically erasable and PROM (EEPROM), magnetic RAM (MRAM), spin-transfer torque MRAM, conductive bridging RAM (CBRAM), ferroelectric RAM (FeRAM), phase change RAM (PRAM), or resistive RAM.

The host 100 and the storage device 200 may communicate with each other through various types of interfaces. As an example, the host 100 and the storage device 200 may be connected to each other through a standard interface such as Universal Serial Bus (USB), multimedia card (MMC), peripheral component interconnection (PCI), PCI-express (PCI-E), advanced technology attachment (ATA), serial-ATA, parallel-ATA, SCSI, enhanced small disk interface (ESDI), Integrated Drive Electronics (IDE), Mobile Industry Processor Interface (MIPI), non-volatile memory express (NVMe), and Compute eXpress link (CXL). The host 100 and the storage device 200 may each generate packets according to the protocol of the adopted interface and transmit the generated packets.

In an embodiment, the system 10 may be implemented as a personal computer (PC) including a desktop computer and a laptop computer, a data server, a network-attached storage (NAS), an internet of things (IoT) device, a workstation, a server, an electric vehicle, or a portable electronic device. The portable electronic device may include laptop computer, mobile phone, smart phones, tablet PC, personal digital assistant (PDA), enterprise digital assistant (EDA), digital still camera, digital video camera, audio device, portable multimedia player (PMP), personal navigation device (PND), MP3 player, handheld game console, e-book, and/or wearable device.

The storage device 200 of the inventive concept may improve a performance of the system 10 by extracting the initiator priorities among the plurality of initiators 110_1 to 110_N included in the host 100 by using the initiator priority table and first processing commands with higher priorities, based on the extracted initiator priorities.

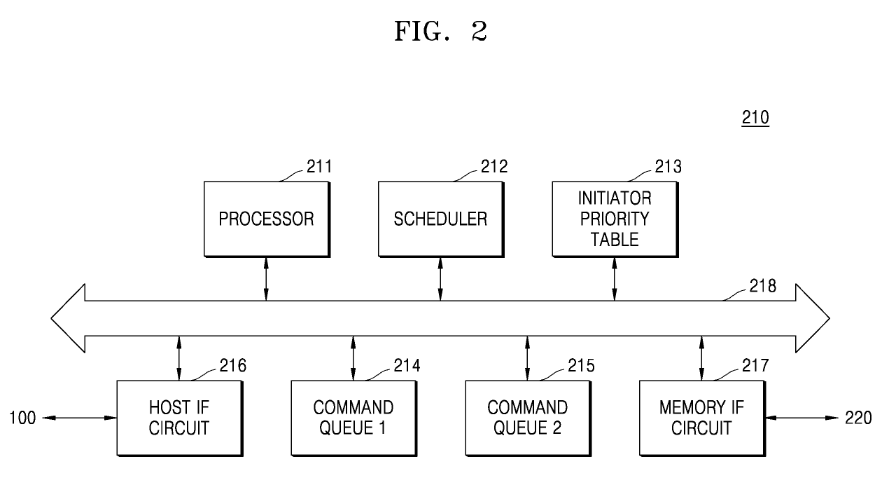

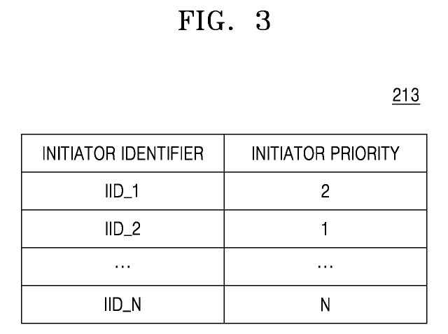

FIG. 2 is a block diagram illustrating a memory controller 210 according to an embodiment. FIG. 3 is a diagram illustrating an initiator priority table 213 according to an embodiment. FIGS. 2 and 3 may be described with reference to FIG. 1, and the description already given may be omitted.

Referring to FIG. 2, the memory controller 210 may include a processor 211, a scheduler 212, an initiator priority table 213, a first command queue 214, a second command queue 215, a host interface circuit 216, and a memory interface circuit 217, which may communicate with each other through a bus 218.

The processor 211 may include a central processing unit or a microprocessor, and may control the overall operation of the memory controller 210. The processor 211 may include one or more processor cores capable of executing a set of instructions of program codes configured to perform a specific operation. For example, the processor 211 may execute a command code of a firmware stored in the memory controller 210.

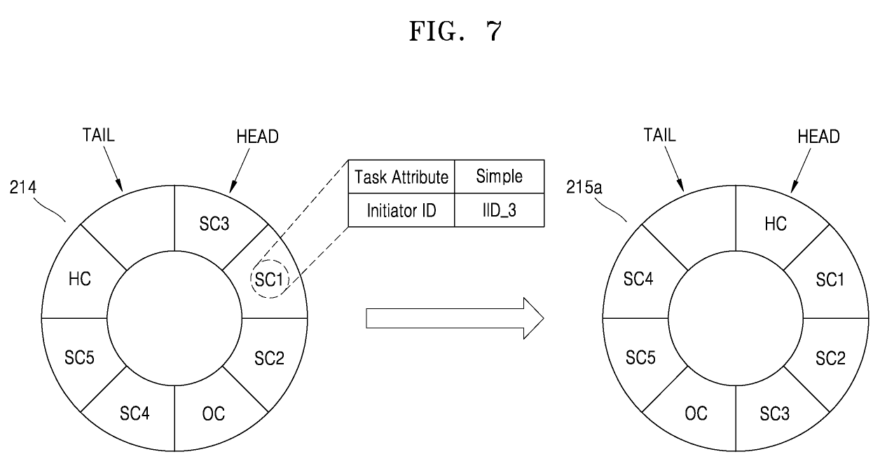

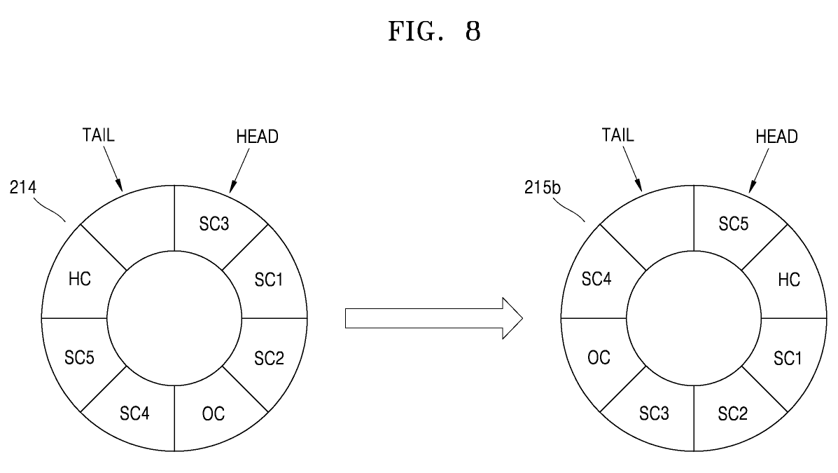

The scheduler 212 may determine a processing order (i.e., an execution order) of commands received from the host 100. The scheduler 212 may extract initiator priority values each corresponding to a respective one of a plurality of commands stored in the first command queue 214 from the initiator priority table 213, and may reorder the processing order of the plurality of commands based on the initiator priority values and the task attribute of each of the plurality of commands. For example, the scheduler 212 may extract an initiator priority value of each command of the plurality of commands stored in the first command queue 214 using the initiator priority table 213, and may reorder the execution order of each of the plurality of commands based on its initiator priority value and task attribute. Depending on an ordering mode, the task attribute may be disregarded in the reordering of the execution order among the plurality of commands. This will be further described with reference to FIGS. 7 and 8.

The task attribute of the command provided from the host 100 may be one of 'simple', 'ordered', and 'head of queue'.

When the task attribute of the command is the 'simple', the task attribute may refer to a most basic attribute. For example, the ‘simple’ task attribute may be set as a default. A command submitted with the ‘simple’ attribute has no ordering requirement, unlike commands with ‘head of queue’ or ‘ordered’ attributes. When multiple simple commands are received from the same initiator, they may be executed in the order they were received. However, if the simple commands are issued by different initiators, their execution order may deviate from the order of receipt and be determined based on initiator priority. When an ordered command is received between two simple commands, the ordered command enforces an execution constraint such that the execution order of the two simple commands and the ordered command follows the receipt order, regardless of initiator priority. For example, if a first group of two simple commands is received before an ordered command, and a second group of three simple commands is received after the ordered command, the execution order will follow the receipt sequence: the first group, the ordered command, and then the second group. Within each group of simple commands, execution order may further be refined based on initiator priority. If the simple commands in a group originate from the same initiator, they are executed in the order received. If they originate from different initiators, the execution order may be rearranged based on the initiator priority. The same prioritization applies to the second group of three simple commands. This will be further described with reference to FIGS. 7 and 8. The scheduler 212 may determine the processing order of the command having the 'simple' attribute based on the initiator priority for efficient processing of commands received from the host 100. In this specification, a command of which task attribute is 'simple' may be referred to as a simple command.

When the task attribute of the command is the 'ordered', this may refer to an attribute that ensures that a particular command should be executed only after previous commands have been processed. A command with the 'ordered' attribute may enforce sequential execution order, and may not execute commands queued after a corresponding command until other commands are completed first. For example, a command submitted with the "ordered" task attribute may be required to be completed in the order it is submitted. This may be used in situations where continuity is important, for example where sequential recording operations must be guaranteed. In this specification, a command of which task attribute is 'ordered' may be referred to as an ordered command.

When the task attribute of the command is the 'head of queue', this means that the command may be processed with priority over commands that are already queued. That is, a command with this attribute may be processed before any commands currently waiting in the queue. In this specification, a command of which task attribute is 'head of queue' may be referred to as a head of queue command or simply a head command. The head command may be prioritized to be executed before other queued commands, regardless of the receipt order.

In some embodiments, the scheduler 212 may determine the processing order such that even if the task attribute of the command is 'simple', the command is processed first when the initiator priority thereof is high. For example, it is assumed that the task attribute of a first command is 'simple', and the task attribute of a second command is 'ordered' or 'head of queue'. In this case, when the initiator priority of the first command is higher than the initiator priority of the second command, the scheduler 212 may adjust the processing order such that the first command is processed first. An example related to this is described below with reference to FIG. 8.

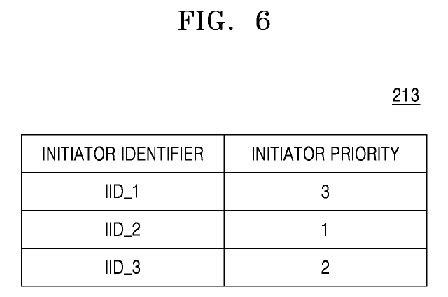

Specific examples and descriptions of how the scheduler 212 reorders the processing order of the plurality of commands stored in the first command queue 214 are described below with reference to FIGS. 6 to 8.

In an embodiment, the scheduler 212 may be implemented as hardware including a logic circuit for determining the processing order of commands received from the host 100. In some embodiments, the scheduler 212 may be referred to as a scheduling circuit.

The initiator priority table 213 may include the initiator identifier information and the initiator priority information as illustrated in FIG. 3. The initiator priority table 213 may be generated based on the configuration descriptor provided by the host 100. The initiator identifier information may include initiator identifiers of the plurality of initiators 110_1 to 110_N included in the host 100. The initiator priority information may include the initiator priorities of the plurality of initiators 110_1 to 110_N included in the host 100. The initiator identifier information and the initiator priority information illustrated in FIG. 3 are examples for explanation and are not intended to limit the inventive concept. In this specification, the initiator identifier information may refer to a set of initiator identifiers forming a first column of the priority table 213. The initiator priority information may refer to a set of initiator priority values forming a second column of the priority table 213.

In an embodiment, the initiator identifier of the first initiator 110_1 may be IID_1, and the initiator priority value of the first initiator 110_1 may be 2. The initiator identifier of the second initiator 110_2 may be IID_2, and the initiator priority value of the first initiator 110_1 may be 1. In this case, a priority of the second initiator 110_2 may be higher than a priority of the first initiator 110_1. In this specification, the lower the initiator priority value, the higher the priority that initiator may have. For example, an initiator with a lower priority value is considered to have a higher priority or to be more senior.

The first command queue 214 may store the plurality of commands. In detail, the first command queue 214 may have a first in first out (FIFO) structure and may store a plurality of commands received from the host 100. In this case, each of the plurality of commands may be issued by the plurality of initiators 110_1 to 110_N included in the host 100. The commands stored in the first command queue 214 may be stored sequentially based on the order received from the host 100. In some embodiments, the first command queue 214 may be referred to as an insert queue.

In an embodiment, when the first command is received by the storage device 200 before the second command, the first command may be stored in the first command queue 214 before the second command.

The second command queue 215 may store a reordered plurality of commands. In detail, the second command queue 215 may be a FIFO structure. The reordered plurality of commands stored in the second command queue 215 may be sequentially inserted by the scheduler 212 that reorders the processing order of the plurality of commands stored in the first command queue 214.

The plurality of commands stored in the first command queue 214 and the reordered plurality of commands stored in the second command queue 215 may be the same commands received from the host 100, but the processing order thereof may be different. For example, the first command and the second command may be stored in the first command queue 214, and the first command and the second command may be stored in the second command queue 215. However, in the first command queue 214, the first command may be stored before the second command, and in the second command queue 240, the second command may be stored before the first command.

The memory controller 210 may perform an operation (e.g., reading, etc.) indicated by a command provided by the host 100 by sequentially executing the reordered commands stored in the second command queue 215 in the order in which they are stored in the second command queue 215. In some embodiments, the second command queue 215 may be referred to as an execute queue.

The host interface circuit 216 may provide an interface between the host 100 and the memory controller 210. The interface may include universal serial bus (USB), MMC, PCI Express (PCI-E), AT attachment (ATA), serial AT attachment (SATA), parallel AT attachment (PATA), SCSI, serial attached SCSI (SAS), enhanced small disk interface (ESDI), or integrated drive electronics (IDE). The host interface circuit 216 may receive requests and data from the host 100 and output data to the host 100.

The memory interface circuit 217 may provide an interface between the memory controller 210 and the non-volatile memory 220. For example, data, commands, and addresses may be transmitted and received between the memory controller 210 and the non-volatile memory 220 via the memory interface circuit 217.

The bus 218 may operate based on various bus architectures. The various bus architectures may include at least one of advanced microcontroller bus architecture (AMBA), advanced high-performance bus (AHB), advanced peripheral bus (APB), advanced extensible interface (AXI), advanced system bus (ASB), and AXI coherency extensions (ACE).

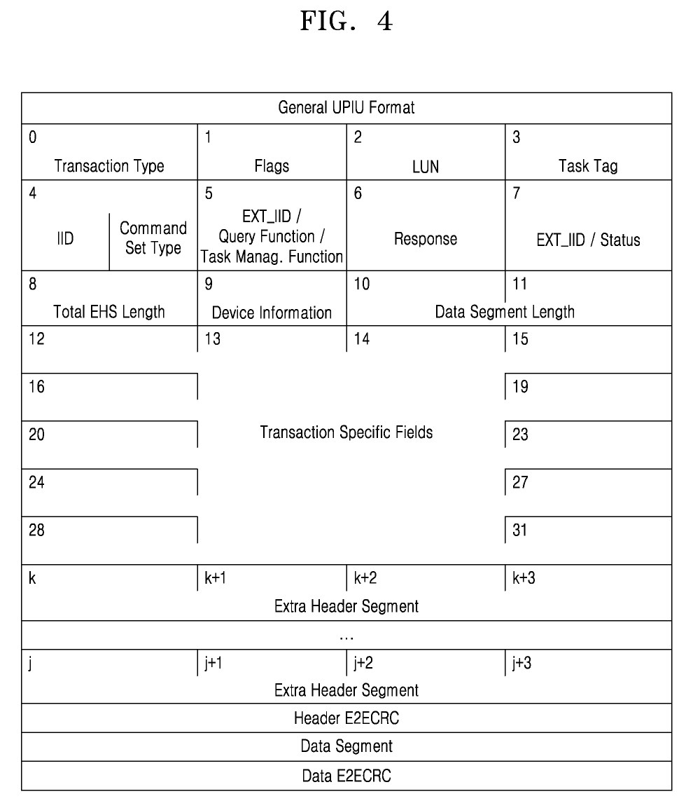

FIG. 4 is a drawing illustrating an implementation example of a command issued by a host according to an embodiment of FIGS. 1 to 3, and the description already given may be omitted.

Referring to FIG. 4, the command issued by the host 100 may conform to the general UFS protocol information unit (UPIU) format defined in the UFS specification. The general UPIU format may refer to a common packet structure for various UPIUs exchanged between the UFS host and the UFS device in the UFS protocol. The general UPIU format may consist of several fields. For example, the general UPIU format may include transaction type, flags, logical unit number (LUN), task tag, initiator identifier (IID), command set type, extended initiator identifier (EXT_IID), query function, task management function, response, status, total extra header segment (EHS) length, device information, data segment length, transaction specific fields, EHS, header end-to-end (E2E) cyclic redundancy check (CRC), and data E2ECRC.

The commands which the host 100 provides to the storage device 200 may include the fields illustrated in FIG. 4, but some of the fields illustrated in FIG. 4 may be omitted in some cases.

The memory controller 210 may check which initiator of the host 100 issued the command through an initiator identifier field of the command received from the host 100. For example, the memory controller 210 may identify the initiator of the host 100 that issued the command by checking an initiator identifier field included in the command received from the host 100.

The memory controller 210 may know the task attribute of the command through a flag field of the command received from the host 100. The memory controller 210 may determine the task attribute of the command by referencing a flag field included in the command received from the host 100.

In an embodiment, the flag field may consist of 8 bits, of which the lower 2 bits may indicate the task attribute of the command. For example, when the lower two bits of the flag field are a first value 2'b00, this may indicate that the command is the simple command. For example, when the lower two bits of the flag field are a second value 2'b01, this may indicate that the command is the ordered command. For example, when the lower two bits of the flag field are a third value 2'b10, this may indicate that the command is the head of queue command.

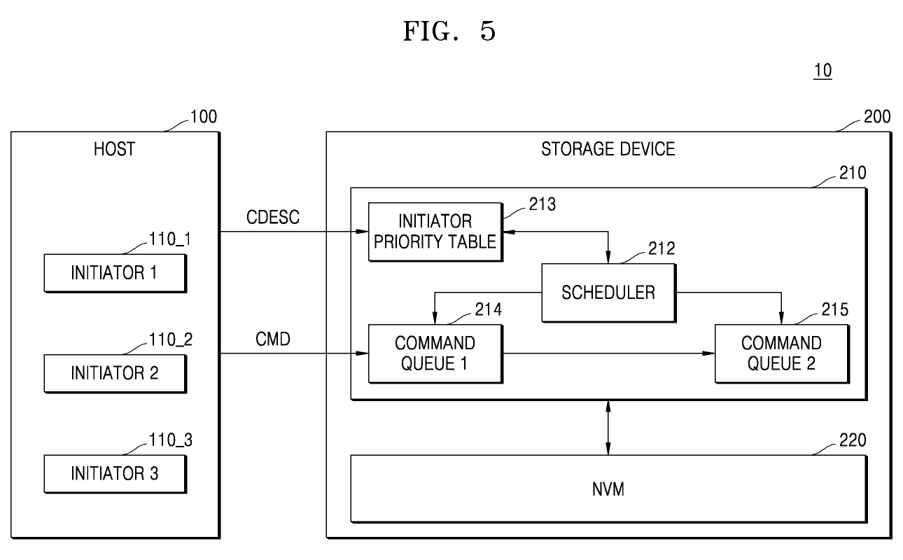

FIG. 5 is a block diagram illustrating a system 10 according to an embodiment. FIG. 6 is a diagram illustrating an initiator priority table 213 according to an embodiment. FIGS. 5 and 6 may be described with reference to FIGS. 1 to 4, and the description already given may be omitted.

Referring to FIG. 5, the host 100 of FIG. 5 may correspond to the host 100 of FIG. 1. Hereinafter, for convenience of description, it is assumed that the host 100 includes three initiators, that is, the first to third initiators 110_1 to 110_3. The storage device 200 of FIG. 5 may correspond to the storage device 200 of FIG. 1. The storage device 200 may include the scheduler 212, the initiator priority table 213, the first command queue 214, and the second command queue 215.

The host 100 may provide a configuration descriptor CDESC to the storage device 200. The configuration descriptor CDESC may be provided to the storage device 200 at a stage where the host 100 recognizes the storage device 200 and performs initial configuration. For example, the configuration descriptor CDESC may be provided to the storage device 200 when power is applied to the host 100 and the storage device 200 and a connection is established between the host 100 and the storage device 200.

The configuration descriptor CDESC may include information about initiators included in the host 100. For example, the configuration descriptor CDESC may include the initiator identifier information and the initiator priority information corresponding to the first to third initiators 110_1 to 110_3.

In an embodiment, the configuration descriptor CDESC may be a value already stored in the host 100.

Referring to FIGS. 5 and 6, the storage device 200 may generate an initiator priority table 213, based on a configuration descriptor CDESC. The initiator priority table 213 may include the initiator identifier information and the initiator priority information corresponding to the first to third initiators 110_1 to 110_3. In FIG. 6, it is assumed that the initiator identifier of the first initiator 110_1 is IID_1 and the initiator priority value of the first initiator 110_1 is 3. It is assumed that the initiator identifier of the second initiator 110_2 is IID_2 and the initiator priority value of the second initiator 110_2 is 1. It is assumed that the initiator identifier of the third initiator 110_3 is IID_3 and the initiator priority value of the third initiator 110_3 is 2. According to the initiator priority table 213 of FIG. 6, the initiator priority may be as follows: the second initiator 110_2 has the highest priority, followed by the third initiator 110_3 and then the first initiator 110_1.

The scheduler 212 may determine the processing order of the plurality of commands stored in the first command queue 214, based on information stored in the initiator priority table 213. The scheduler 212 may perform an operation instructed by the host 100 by sequentially executing the reordered plurality of commands stored in the second command queue 215.

The first command queue 214 may store commands CMD depending on an order of the commands CMD received from the host 100.

The second command queue 215 may store the reordered plurality of commands. In this specification, the reordered plurality of commands stored in the second command queue 215 may be the same commands as the plurality of commands stored in the first command queue 214, but may refer to commands having different processing orders.

In some embodiments, the first command queue 214 and the second command queue 215 may store all commands CMD, or may store only some information of the command CMD (e.g., initiator identifier, task attribute, etc.).

FIGS. 7 and 8 are drawings illustrating the first command queue 214 and the second command queue 215 according to an embodiment. FIGS. 7 and 8 may be described with reference to FIGS. 1 to 6, and the description already given may be omitted.

In FIGS. 7 and 8, it is assumed that the scheduler 212 determines a processing order of a command CMD received from the host 100, based on the initiator priority table 213 of FIG. 6. Additionally, it is assumed that the first initiator 110_1 issued a third simple command SC3, an ordered command OC, and a fourth simple command SC4. It is assumed that the second initiator 110_2 issued a fifth simple command SC5. It is assumed that the third initiator 110_3 issues a head of queue command HC, a first simple command SC1, and a second simple command SC2.

Referring to FIGS. 7 and 8, the first command queue 214 may correspond to the first command queue 214 of FIG. 5. A second command queue 215a of FIG. 7 and a second command queue 215b of FIG. 8 may each correspond to the second command queue 215 of FIG. 5.

The first command queue 214 may store a plurality of commands. In this case, the plurality of commands may be stored in the first command queue 214 according to the order in which the commands are sequentially received from the host 100. The first received command may be located at a head of the first command queue 214, and the last received command may be located at a tail of the first command queue 214. For example, the first command queue 214 may store in the order of the third simple command SC3, the first simple command SC1, the second simple command SC2, the ordered command OC, the fourth simple command SC4, the fifth simple command SC5, and the head of queue command HC.

The scheduler 212 may determine the processing order of the plurality of commands, based on information about each of the plurality of commands stored in the first command queue 214 and the initiator priority table 213. The scheduler 212 may sequentially store the reordered plurality of commands in the second command queue 215a, based on a determined processing order.

Because the head of queue command HC has the task attribute of being the head of queue, the scheduler 212 may store the head of queue command HC in the head of the second command queue 215a.

Because the first simple command SC1 and the second simple command SC2 are both commands issued from the third initiator 110_3, the scheduler 212 may store the first simple command SC1, which is received first by the memory controller 210, in the second command queue 215a before the second simple command SC2.

In the case of the third simple command SC3, because the third simple command SC3 is a command issued from the first initiator 110_1, and the priority of the first initiator 110_1 is lower than that of the third initiator 110_3 according to the initiator priority table 213 of FIG. 6, the scheduler 212 may store the third simple command SC3 in the second command queue 215a such that the third simple command SC3 is positioned after the first simple command SC1 and the second simple command SC2.

Because the ordered command OC has a task attribute of being 'ordered' and is a command received after the third simple command SC3, the scheduler 212 may store the ordered command OC in the second command queue 215a such that the ordered command OC is positioned after the third simple command SC3.

Because the fourth simple command SC4 and the fifth simple command SC5 are commands received after the ordered command OC, the scheduler 212 may store the fourth simple command SC4 and the fifth simple command SC5 in the second command queue 215a such that the fourth simple command SC4 and the fifth simple command SC5 are positioned after the ordered command OC.

In the case of the fourth simple command SC4, the command is issued from the first initiator 110_1, and because the priority of the first initiator 110_1 is lower than that of the second initiator 110_2 according to the initiator priority table 213 of FIG. 6, the scheduler 212 may store the fourth simple command SC4 in the second command queue 215a such that the fourth simple command SC4 is positioned after the fifth simple command SC5.

The order of the reordered plurality of commands stored in the second command queue 215a by the scheduler 212 may be the head of queue command HC, the first simple command SC1, the second simple command SC2, the third simple command SC3, the ordered command OC, the fifth simple command SC5, and the fourth simple command SC4. The scheduler 212 may execute commands depending on an order stored in the second command queue 215a. For example, a first group of simple commands includes the third simple command SC3, the first simple command SC1, and the second simple command SC2. The first group of simple commends is received prior to the receipt of the ordered command OC. A second group of simple commands includes the fourth simple command SC4 and the fifth simple command SC5. The second group of simple commands is received after the receipt of the ordered command OC. Due to the restriction in the execution order of the ordered command OC, the first group of simple commands is stored in the second command queue 215a prior to the ordered command OC, and the second group of simple command is stored in the second command queue 215a after the ordered command OC. The head of queue command HC is stored at the head of the second command queue 215a according to the priority of the head of queue command HC. The three simple commands SC3, SC1, and SC2 are stored in an order different from the receipt order in the second command queue 215a according to their initiator priorities. The initiator priority of the first and second simple commands SC1 and SC2 is senior to the initiator priority of the third simple command SC3, and thus although the third simple command SC3 is received earlier than the first and second simple commands SC1 and SC2, the third simple command SC3 is stored after the first and second simple commands SC1 and SC2 in the second command queue 215a. The first and second simple commands SC1 and SC2 have the same initiator priority, and thus they are stored in the second command queue 215a in the receipt order. Similarly, the two simple commands SC4 and SC5 received after the ordered command OC are stored in the second command queue 215a according to their initiator priorities. This ordering operation may correspond to a first mode (i.e., a first ordering mode) in which both an initiator priority value and a task attribute of each command is considered in determining an execution order (or an order of storing the command), which will be described later with reference to FIG. 7. The scheduler 212 of the memory controller 210 may operate in a second mode in which the scheduler 212 may order the commands according to the initiator priority only. In the second mode, the task attributes of the commands are disregarded in determining the execution order of the commands. This will be described later with reference to FIG. 8.

Referring to FIG. 8, a configuration of commands stored in the first command queue 214 of FIG. 8 is the same as that of FIG. 7.

The scheduler 212 may determine the processing order of the plurality of commands based on information about each of the plurality of commands stored in the first command queue 214 and the initiator priority table 213. However, in the embodiment of FIG. 8, unlike the embodiment of FIG. 7, the scheduler 212 may determine the processing order of commands by giving top priority to the initiator priority when determining the processing order of commands.

In this specification, when the scheduler 212 operates according to a scheduling policy such as the embodiment of FIG. 7, it may be referred to as the scheduler 212 operating in a first mode (i.e., a first ordering mode), and when the scheduler 212 operates according to the scheduling policy such as the embodiment of FIG. 8, it may be referred to as the scheduler 212 operating in a second mode (i.e., a second ordering mode). Whether the scheduler 212 operates in the first mode or the second mode may be determined by a value preset in the scheduler 212, or may be changed depending on the request of the host 100.

In the case of the fifth simple command SC5, because the fifth simple command SC5 is a command issued by the third initiator 110_3, which is the initiator with the highest priority, considering the initiator priority table 213 of FIG. 6, the fifth simple command SC5 may be positioned in the head of the second command queue 215b.

For the first simple command SC1, the second simple command SC2, and the head of queue command HC, all of them may be commands issued from the third initiator 110_3. Considering that the priority of the third initiator 110_3 is higher than that of the first initiator 110_1 and lower than that of the second initiator 110_2, the scheduler 212 may store the first simple command SC1, the second simple command SC2, and the head of queue command HC in the second command queue 215b such that they are positioned after the fifth simple command SC5.

Because the head of queue command HC has the task attribute of being the 'head of queue', the scheduler 212 may store the head of queue command HC in the second command queue 215b before the first simple command SC1 and the second simple command SC2.

Because the first simple command SC1 has the same initiator priority as the second simple command SC2 and also has the same task attribute as the second simple command SC2, the scheduler 212 may first store the first simple command SC1 received before the second simple command SC2 in the second command queue 215b.

The third simple command SC3, the ordered command OC, and the fourth simple command SC4 may all be commands issued by the first initiator 110_1. Considering that the priority of the first initiator 110_1 is lower than that of the third initiator 110_3, the scheduler 212 may store the third simple command SC3, the ordered command OC, and the fourth simple command SC4 in the second command queue 215b such that they are positioned after the second simple command SC2.

Because the third simple command SC3 has the same initiator priority as the ordered command OC and the fourth simple command SC4 and is a command stored in the first command queue 214 before the ordered command OC and the fourth simple command SC4, the scheduler 212 may store the third simple command SC3 in the second command queue 215b before the ordered command OC and the fourth simple command SC4.

Because the ordered command OC has the same initiator priority as the fourth simple command SC4 and is a command stored in the first command queue 214 before the fourth simple command SC4, the scheduler 212 may store the ordered command OC in the second command queue 215b before the fourth simple command SC4.

The order of the reordered plurality of commands stored in the second command queue 215b by the scheduler 212 may be the fifth simple command SC5, the head of queue command HC, the first simple command SC1, the second simple command SC2, the third simple command SC3, the ordered command OC, and the fourth simple command SC4. The scheduler 212 may execute commands depending on the order stored in the second command queue 215b.

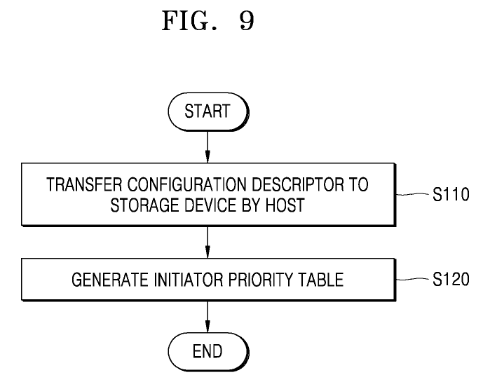

FIG. 9 is a flowchart illustrating an operation method of a memory controller 210 according to an embodiment. FIG. 9 may be described with reference to FIGS. 1 to 8, and the description already given may be omitted.

Referring to FIG. 9, in operation S110, the memory controller 210 may receive the configuration descriptor from the host 100. The configuration descriptor may include the initiator priority information and the initiator identifier information for the plurality of initiators 110_1 to 110_N of the host 100.

In an embodiment, the configuration descriptor may be provided in the operation where the host 100 recognizes the storage device 200 and performs initial configuration. For example, the configuration descriptor may be provided when power is applied to the host 100 and the storage device 200 and a connection is established between the host 100 and the storage device 200 (i.e., in a booting process of the host 100).

In operation S120, the memory controller 210 may generate the initiator priority table 213, based on the received configuration descriptor.

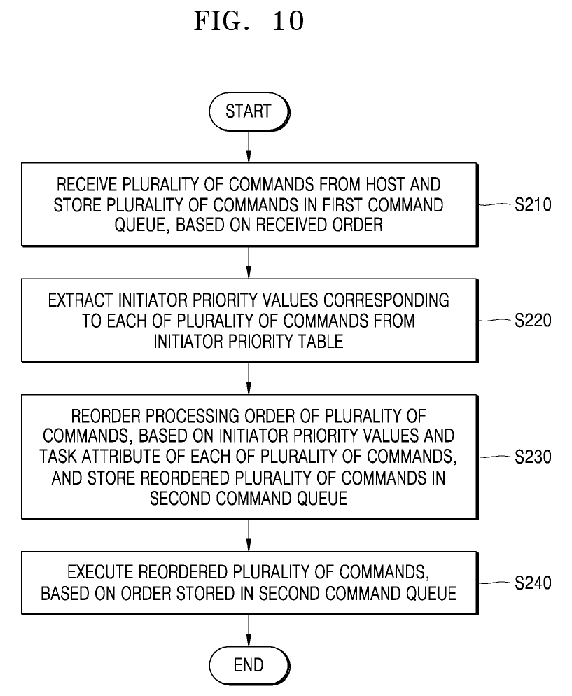

FIG. 10 is a flowchart illustrating an operation method of a memory controller 210, according to an embodiment. FIG. 10 may be described with reference to FIGS. 1 to 8, and the description already given may be omitted.

Referring to FIG. 10, in operation S210, the memory controller 210 may receive the plurality of commands issued by the plurality of initiators 110_1 to 110_N from the host 100 and store the plurality of commands in the first command queue 214, based on the order in which the commands were received.

In operation S220, the memory controller 210 may extract initiator priority values of the plurality of commands from the initiator priority table 213.

In operation S230, the memory controller 210 may reorder the processing order of a plurality of commands, based on the initiator priority values and the task attribute of each of the plurality of commands, and store the reordered plurality of commands in the second command queue 215.

In an embodiment, the memory controller 210 may store a command of which the task attribute is 'head of queue ' among the plurality of commands stored in the first command queue 214 in the head of the second command queue 215.

In an embodiment, it is assumed that the first command and the second command sequentially received from the host 100 are stored in the first command queue 214. In this case, when the task attributes of the first command and the second command are the same and the priority of the initiator that issued the second command is higher than the priority of the initiator that issued the first command, the memory controller 210 may store the second command in the second command queue before the first command.

In an embodiment, it is assumed that the first command queue 214 stores the first command and the second command sequentially received from the host 100 and the first command and the second command are issued from different initiators with different priorities. In this case, the memory controller 210 may extract, by the scheduler 212, a first initiator priority value corresponding to an initiator identifier of the first command from the initiator priority table 213 and a second initiator priority value corresponding to initiator identifier information of the second command from the initiator priority table 213. The memory controller 210 may determine an order of storing the first command and the second command in the second command queue, based on the first initiator priority value and the second initiator priority value. The order of storing the first command and the second command (i.e., an execution order of the first command and the second command) may be set depending on an ordering mode of the scheduler 212 as describe with reference to FIGS. 7 and 8.

In an embodiment, it is assumed that the first command queue 214 stores ordered commands and simple commands sequentially received from the host 100 and the ordered commands and simple commands are issued from different initiators with different priorities. When the scheduler 212 operates in the first mode and a priority of an initiator that issued the simple command is higher than the priority of the initiator that issued the ordered command, the memory controller 210 may store the ordered command in the second command queue 215 before the simple command according the restriction of the execution order of the ordered command.

In an embodiment, it is assumed that the first command queue 214 stores an ordered command and a simple command that are sequentially received from the host 100, and the ordered command and the simple command are issued from different initiators with different priorities. When the scheduler 212 operates in the second mode and a priority of the initiator that issued the simple command is higher than a priority of the initiator that issued the ordered command, the memory controller 210 may store the simple command in the second command queue 215 before the ordered command according to the initiator priority. In the second mode, the initiator priority may override the execution order of the ordered command.

In operation S240, the memory controller 210 may execute the reordered plurality of commands, based on the order stored in the second command queue 215.

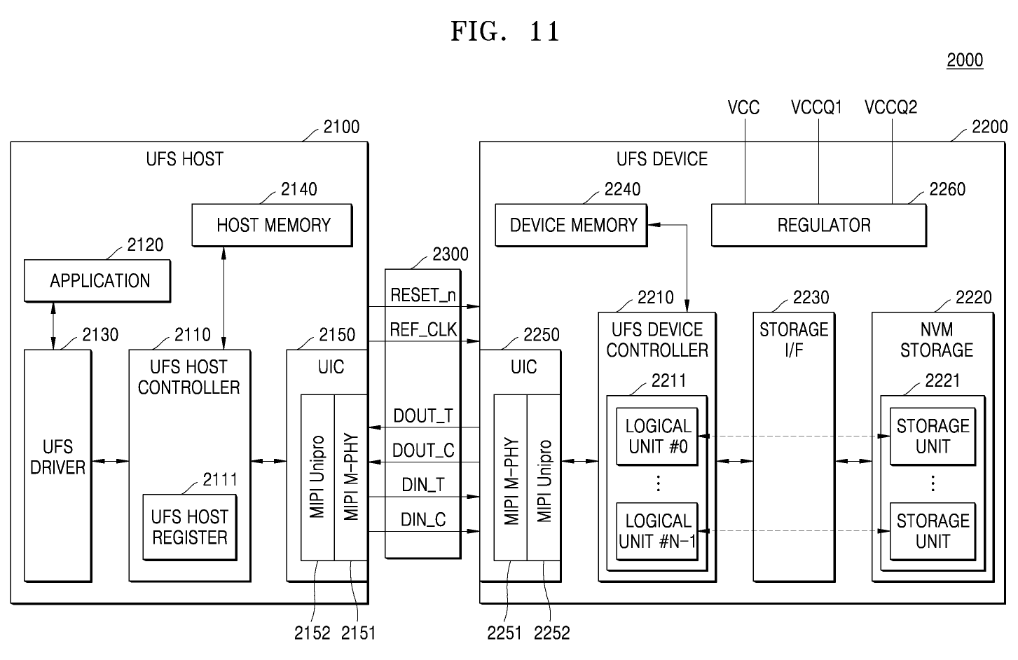

FIG. 11 is a block diagram illustrating a UFS system 2000 according to an embodiment. The UFS system 2000 is a system that conforms to the UFS standard announced by JEDEC and may include a UFS host 2100, a UFS device 2200, and a UFS interface 2300.

Referring to FIG. 11, the UFS host 2100 and the UFS device 2200 may be interconnected through the UFS interface 2300. The UFS host 2100 may include a UFS host controller 2110, an application 2120, a UFS driver 2130, host memory 2140, and a UFS interconnect (UIC) layer 2150. The UFS device 2200 may include a UFS device controller 2210, non-volatile storage 2220, a storage interface 2230, device memory 2240, a UIC layer 2250, and a voltage regulator 2260. The non-volatile storage 2220 may include a plurality of storage units 2221, and the storage units 2221 may include a 2D flash memory or a V-NAND flash memory having a 3D structure, but may also include other types of non-volatile memory such as PRAM and/or RRAM. The UFS device controller 2210 and non-volatile storage 2220 may be connected to each other through the storage interface 2230. The storage interface 2230 may be implemented to conform to standard protocols such as toggle or open NAND flash interface working group (ONFI).

The application 2120 may mean a program that desires to communicate with the UFS device 2200 to utilize the functions of the UFS device 2200. The application 2120 may send an input-output request (IOR) to the UFS driver 2130 for input/output to the UFS device 2200. The IOR may mean, but is not necessarily limited to, a request to read data, a request to write data, and/or a request to discard data.

The UFS driver 2130 may manage the UFS host controller 2110 through the UFS host controller interface (UFS-HCI). The UFS driver 2130 may convert IOR generated by the application 2120 into UFS command defined by the UFS standard and transmit the converted UFS command to the UFS host controller 2110. A single IOR may be translated into a plurality of UFS commands. The UFS commands may include commands similar to those defined in the SCSI standard, as well as commands specific to the UFS standard.

The UFS host controller 2110 may transmit the UFS command converted by the UFS driver 2130 to the UIC layer 2250 of the UFS device 2200 through the UIC layer 2150 and the UFS interface 2300. In this process, a UFS host register 2111 of the UFS host controller 2110 may serve as a command queue (CQ).

The UIC layer 2150 of the UFS host 2100 may include an MIPI M-PHY 2151 and an MIPI UniPro 2152, and the UIC layer 2250 of the UFS device 2200 may also include an MIPI M-PHY 2251 and an MIPI UniPro 2252.

The UFS interface 2300 may include a line transmitting a reference clock REF_CLK, a line transmitting a hardware reset signal RESET_n for the UFS device 2200, a pair of lines transmitting a differential input signal pair DIN_t and DIN_c, and a pair of lines transmitting a differential output signal pair DOUT_t and DOUT_c.

The frequency value of the reference clock REF_CLK provided from the UFS host 2100 to the UFS device 2200 may be one of four values: 19.2 MHz, 26 MHz, 38.4 MHz, and 52 MHz, but is not necessarily limited thereto. The UFS host 2100 may change the frequency value of the reference clock REF_CLK even while in operation, that is, while data transmission and reception are performed between the UFS host 2100 and the UFS device 2200. The UFS device 2200 may generate clocks of various frequencies from a reference clock REF_CLK provided from the UFS host 2100 using a phase-locked loop (PLL). The UFS host 2100 may also set the data rate value between the UFS host 2100 and the UFS device 2200 through the frequency value of the reference clock REF_CLK. That is, the value of the data rate may be determined depending on the frequency value of the reference clock REF_CLK.

The UFS interface 2300 may support a plurality of signal line, and each signal line may be implemented as a differential pair. For example, the UFS interface may include one or more reception signal lines and one or more transmission signal lines. In FIG. 11, a pair of lines transmitting the differential input signal pair DIN_T and DIN_C may include the reception signal line, and a pair of lines transmitting the differential output signal pair DOUT_T and DOUT_C may include the transmission signal line. Although FIG. 11 illustrates one transmission signal line and one reception signal line, the number of transmission signal lines and reception signal lines may be changed.

The reception signal line and the transmission signal line may transmit data in a serial communication manner, and full-duplex communication between the UFS host 2100 and the UFS device 2200 is possible due to the structure in which the reception signal line and the transmission signal line are separated. That is, the UFS device 2200 may transmit data to the UFS host 2100 through the transmission signal line while receiving data from the UFS host 2100 through the reception signal line. In addition, control data and user data may be transmitted through the same signal line, the control data being data such as commands from the UFS host 2100 to the UFS device 2200, and the user data being data the UFS host 2100 wants to store in or read from the non-volatile storage 2220 of the UFS device 2200. Accordingly, there is no need to provide a separate signal line for data transmission other than a pair of reception signal lines and a pair of transmission signal lines between the UFS host 2100 and the UFS device 2200.

The UFS device controller 2210 of the UFS device 2200 may control the overall operation of the UFS device 2200. The UFS device controller 2210 may manage non-volatile storage 2220 through a logical unit (LU) 2211, which is a logical data storage unit. The number of LUs 2211 may be 8, but is not limited thereto. The UFS device controller 2210 may include a flash translation layer (FTL) and may convert a logical data address, such as a logical block address (LBA), transmitted from the UFS host 2100 into a physical data address, such as a physical block address (PBA), using the address mapping information of the FTL. In the UFS system 2000, a logical block for storing user data may have a size within a certain range. For example, the minimum size of a logical block may be set to 4Kbytes.

When a command from the UFS host 2100 is input to the UFS device 2200 through the UIC layer 2250, the UFS device controller 2210 may perform an operation according to the input command and, when the operation is completed, the UFS device controller 2210 may transmit a completion response to the UFS host (2100).

As an example, when the UFS host 2100 wants to store user data in the UFS device 2200, the UFS host 2100 may transmit a data storage command to the UFS device 2200. When a ready-to-transfer response indicating that user data is ready to be transferred is received from the UFS device 2200, the UFS host 2100 may transfer the user data to the UFS device 2200. The UFS device controller 2210 may temporarily store the received user data in the device memory 2240 and may store the user data temporarily stored in the device memory 2240 in a selected location of the non-volatile storage 2220, based on the address mapping information of the FTL.

As another example, when the UFS host 2100 wants to read user data stored in a UFS device 2200, the UFS host 2100 may transmit a data read command to the UFS device 2200. The UFS device controller 2210 that receives the command may read user data from the non-volatile storage 2220, based on the data read command and temporarily store the read user data in the device memory 2240. During this read process, the UFS device controller 2210 may detect and correct errors in the read user data using a built-in error correction code (ECC) circuit (not shown). Additionally, the UFS device controller 2210 may transmit user data temporarily stored in the device memory 2240 to the UFS host 2100. The UFS device controller 2210 may further include an advanced encryption standard (AES) circuit (not shown), and the AES circuit may encrypt or decrypt data input to the UFS device controller 2210 using a symmetric key algorithm.

The UFS host 2100 may sequentially store commands to be transmitted to the UFS device 2200 in the UFS host register 2111 that may function as a command queue and may transmit the commands to the UFS device 2200 in the sequential order. In this case, the UFS host 2100 may transmit the next command waiting in the command queue to the UFS device 2200 even if the previously transmitted command is still being processed by the UFS device 2200, that is, even before receiving a notification that the previously transmitted command has been completed by the UFS device 2200, and accordingly, the UFS device 2200 may also receive the next command from the UFS host 2100 even while processing the previously transmitted command. A queue depth, which is the maximum number of commands that may be stored in a command queue, may be, for example, 32. Additionally, the command queue may be implemented as a circular queue type that indicates the start and end of the command sequence stored in the queue through a head pointer and a tail pointer, respectively.

Each of the plurality of storage units 2221 may include a memory cell array and a control circuit that controls the operation of the memory cell array. The memory cell array may include a two-dimensional memory cell array or a three-dimensional memory cell array. The memory cell array includes a plurality of memory cells, and each memory cell may be a single level cell (SLC), which stores 1 bit of information, but may also be a cell that stores 2 or more bits of information, such as a multi-level cell (MLC), a triple level cell (TLC), and a quadruple level cell (QLC). The three-dimensional memory cell array may include vertical NAND strings that are vertically oriented such that at least one memory cell is positioned above another memory cell.

Power voltages such as VCC, VCCQ1, VCCQ2 may be input to the UFS device 2200. The VCC is the main power voltage for the UFS device 2200 and may have a value of about 2.4 V to about 3.6 V. The VCCQ is a power supply voltage for supplying a low range of voltage, mainly for the UFS device controller 2210, and may have a value of about 1.14 V to about 1.26 V. The VCCQ2 is a power supply voltage for supplying a voltage in a range lower than the VCC but higher than the VCCQ, and is mainly for input/output interfaces such as MIPI M-PHY 2251, and may have a value of about 1.7 V to about 1.95 V. The power voltages may be supplied to each component of the UFS device 2200 through the voltage regulator 2260. The voltage regulator 2260 may be implemented as a set of unit regulators, each connected to a different one of the aforementioned power supply voltages.

While the inventive concept has been particularly shown and described with reference to embodiments thereof, it will be understood that various changes in form and details may be made therein without departing from the spirit and scope of the following claims.

What is claimed is:

1. A memory controller communicating with a host device including a plurality of initiators, the memory controller comprising:
an initiator priority table including priority information of each of the plurality of initiators, wherein the plurality of initiators are identified by using a plurality of initiator identifiers;
a first command queue configured to store a plurality of commands issued by the plurality of initiators in a receipt order in which the plurality of commands are received from the host device;
a scheduler configured to:
extract a plurality of initiator priority values of the plurality of commands stored in the first command queue from the initiator priority table, and
reorder the plurality of commands in an execution order, based on the plurality of initiator priority values and a plurality of task attributes of the plurality of commands; and
a second command queue configured to store the plurality of commands in the execution order,
wherein the scheduler is configured further to execute, in the execution order, the plurality of commands stored in the second command queue.

2. The memory controller of claim 1,
wherein the initiator priority table includes initiator identifier information and initiator priority information of each initiator of the plurality of initiators.

3. The memory controller of claim 1,
wherein a format of the plurality of commands corresponds to a universal flash storage (UFS) standard protocol information unit (UPIU) format defined in a UFS standard, and
wherein each command of the plurality of commands issued by the plurality of initiators includes a corresponding task attribute of the plurality of task attributes and a corresponding initiator identifier of the plurality of initiator identifiers.

4. The memory controller of claim 1,
wherein the scheduler is configured further to store a command of which a task attribute is a head of queue among the plurality of commands stored in the first command queue in a head of the second command queue.

5. The memory controller of claim 3,
wherein the first command queue is configured further to store a first command and a second command sequentially received from the host device,
wherein a task attribute of the first command is identical to a task attribute of the second command,
wherein an initiator priority value of the second command is senior to an initiator priority value of the first command, and
wherein the scheduler is configured further to store the second command before the first command in the second command queue.

6. The memory controller of claim 5,
wherein the scheduler is configured further to:
extract a first initiator priority value of the first command from the initiator priority table using an initiator identifier of the first command,
extract a second initiator priority value of the second command from the initiator priority table using an initiator identifier of the second command, and
determine the execution order of the first command and the second command based on the first initiator priority value and the second initiator priority value.

7. The memory controller of claim 1,
wherein the first command queue is configured further to store an ordered command and a simple command sequentially received from the host device,
wherein an initiator priority value of the simple command is senior to an initiator priority value of the ordered command, and
wherein the scheduler is configured further to:
store, in a first ordering mode, the ordered command before the simple command in the second command queue, and
store, in a second ordering mode in which the plurality of task attributes are disregarded in the reordering of the plurality of commands, the simple command before the ordered command in the second command queue.

8. A method of operating a memory controller communicating with a host device including a plurality of initiators, the method comprising:
receiving a plurality of commands issued by the plurality of initiators from the host device;
storing the plurality of commands in a first command queue in a receipt order of the plurality of commands from the host device;
extracting a plurality of initiator priority values of the plurality of commands from an initiator priority table;
storing the plurality of commands in a second command queue in an execution order based on the plurality of initiator priority values and a plurality of task attributes of the plurality of commands; and
executing, in the execution order, the plurality of commands stored in the second command queue.

9. The method of claim 8, further comprising:
receiving a configuration descriptor including initiator priority information and initiator identifier information of each initiator of the plurality of initiators from the host device; and
storing the initiator priority information and the initiator identifier information in the initiator priority table.

10. The method of claim 8,
wherein a format of the plurality of commands corresponds to a universal flash storage (UFS) protocol information unit (UPIU) format defined in a UFS standard, and
wherein each command of the plurality of commands issued by the plurality of initiators includes an initiator identifier indicating a corresponding initiator of the plurality of initiators and a corresponding task attribute among the plurality of task attributes.

11. The method of claim 8,
wherein the storing of the plurality of commands in the second command queue comprises:
storing a command of which a task attribute is a head of queue among the plurality of commands stored in the first command queue in a head of the second command queue.

12. The method of claim 8,
wherein the receiving of the plurality of commands comprises receiving a first command and a second command sequentially from the host device, a task attribute of the first command being identical to a task attribute of the second command, and an initiator priority value of the second command being senior to an initiator priority value of the first command, and
wherein the storing of the plurality of commands comprises storing the second command before the first command in the second command queue.

13. The method of claim 12,
wherein the extracting of the plurality of initiator priority values from the initiator priority table comprises:
extracting a first initiator priority value of the first command from the initiator priority table using an initiator identifier of the first command; and
extracting a second initiator priority value of the second command from the initiator priority table using an initiator identifier of the second command, and
wherein the storing of the plurality of commands in the second command queue is performed based on the first initiator priority value and the second initiator priority value.

14. The method of claim 8,
wherein the receiving of the plurality of commands comprises receiving, by the first command queue, an ordered command and a simple command sequentially from the host device, an initiator priority value of the simple command being senior to an initiator priority value of the ordered command, and
wherein the storing of the plurality of commands in the second command queue comprises:
storing, in a first ordering mode, the ordered command before the simple command in the second command queue; and
storing, in a second ordering mode in which the plurality of task attributes are disregarded in the storing of the plurality of commands in the second command queue, the simple command before the ordered command in the second command queue.

15. A system comprising a host device and a memory controller communicating with the host device,
wherein the host device comprises:
a first initiator and a second initiator which issue a plurality of commands, and
wherein the memory controller comprises:
an initiator priority table including initiator identifier information and initiator priority information of each initiator of the first initiator and the second initiator;
a first command queue configured to store the plurality of commands in a receipt order in which the plurality of commands are received from the host device;
a scheduler configured to:
extract a plurality of initiator priority values of the plurality of commands stored in the first command queue from the initiator priority table, and
reorder the plurality of commands in an execution order, based on the plurality of initiator priority values and a plurality of task attributes of the plurality of commands; and
a second command queue configured to store the plurality of commands in the execution order.

16. The system of claim 15,
wherein the host device is configured to provide the memory controller with a configuration descriptor including the initiator priority information and the initiator identifier information of each initiator of the first initiator and the second initiator, and
wherein the memory controller is configured to store the initiator priority information and the initiator identifier information in the initiator priority table.

17. The system of claim 15,
wherein a format of the plurality of commands corresponds to a Universal Flash Storage (UFS) standard protocol information unit (UPIU) format defined in a UFS standard, and
wherein each command of the plurality of commands issued by the first initiator and the second initiator includes a corresponding task attribute of the plurality of task attributes and a corresponding initiator identifier of the first initiator and the second initiator.

18. The system of claim 15,
wherein the initiator priority table includes an initiator identifier and an initiator priority value of each initiator of the first initiator and the second initiator, and
wherein an initiator priority value of the second initiator is senior to an initiator priority value of the first initiator.

19. The system of claim 15,
wherein the first command queue is configured further to store a first command and a second command sequentially received from the host device,
wherein a task attribute of the first command is identical to a task attribute of the second command,
wherein an initiator priority value of the second command is senior to an initiator priority value of the first command, and
wherein the scheduler is configured further to store the second command before the first command in the second command queue.

20. The system of claim 19,
wherein the scheduler is configured further to:
extract a first initiator priority value of the first command from the initiator priority table using an initiator identifier of the first command,
extract a second initiator priority value of the second command from the initiator priority table using an initiator identifier of the second command, and
determine the execution order of the first command and the second command based on the first initiator priority value and the second initiator priority value.
